(19) United States
(12) Patent Application Publication
(10) Pub. No.: US 2012/0161703 A1
(43) Pub. Date: Jun. 28, 2012

(54) TRANSPORT MODULE FOR A PORTABLE ELECTRIC VEHICLE CHARGING DEVICE

(75) Inventor: Barbara M. Gonzalez, Clinton, MD (US)

(73) Assignee: PEPCO HOLDINGS, INC., Washington, DC (US)

(21) Appl. No.: 13/334,874

(22) Filed: Dec. 22, 2011

Related U.S. Application Data
(60) Provisional application No. 61/427,349, filed on Dec. 27, 2010.

(51) Int. Cl. H02J 7/00; B62B 3/00

(52) U.S. Cl. 320/109; 280/79.11

(57) ABSTRACT

A transport device for an electric vehicle charging device is provided. The transport module may include a platform having a through hole; a plurality of wheels coupled to a bottom surface of the platform; and a cable guide element coupled to the bottom surface of the platform beneath the though hole. When the transport module is coupled to the electric vehicle charging device, a service entrance cable extends from electric vehicle supply equipment of the electric vehicle charging device through the through hole and is supported and guided in the cable guide element. A portable electric vehicle charging device including the transport module may also be provided.

### CROSS-REFERENCE TO RELATED APPLICATION

This application claims priority under 35 U.S.C. §119(e) to U.S. Provisional Application No. 61/427,349 filed Dec. 27, 2010, the entire contents of which are hereby incorporated by reference.

### BACKGROUND

1. Field of Invention

The invention relates to electric vehicle service equipment and electric vehicle charging stations and, more particularly, to a transport module for a portable electric vehicle charging device.

2. Related Art

Electric and hybrid-electric automobiles are quickly gaining popularity in the U.S. and around the world. One previous obstacle to wide-spread acceptance was the lack of a sufficient infrastructure, including easily accessible service equipment for charging such vehicles. Several different methods and systems for connecting electric vehicles to off-board equipment for charging have been developed including, for example, cord-and-plug connected adapters that can be transported with an electric vehicle and are configured to be compatible with the most commonly available grounded electrical outlet. Such adapters typically have a rating of less than 120 VAC and 15 A. Higher rated electric vehicle supply equipment (e.g., rated at 208-240 VAC, 30-100 A or higher) is also available in the form of wall-mounted or pedestal-mounted electric vehicle charge systems configured for permanent installation at a fixed location.

### SUMMARY

In accordance with an embodiment of the invention, a portable electric vehicle charging device is provided. The portable electric vehicle charging device may include electric vehicle supply equipment, a pedestal, and a transport module. The electric vehicle supply equipment may include a service entrance cable and an electric vehicle connector configured for connection to an electric vehicle inlet. At least a portion of the electric vehicle supply equipment may be disposed in a housing enclosure. The pedestal may be coupled to and support the housing enclosure and may include a base. The transport module may be coupled to the base of the pedestal and may include a platform having a through hole, a plurality of wheels coupled to a bottom surface of the platform, and a cable guide element coupled to the bottom surface of the platform beneath the though hole. The service entrance cable may extend from the housing enclosure through the through hole and may be supported and guided in the cable guide element.

In accordance with another embodiment of the invention, a transport module for an electric vehicle charging device may be provided. The transport module may include a platform having a through hole; a plurality of wheels coupled to a bottom surface of the platform; and a cable guide element coupled to the bottom surface of the platform beneath the though hole. When the transport module is coupled to the electric vehicle charging device, a service entrance cable extends from electric vehicle supply equipment of the electric vehicle charging device through the through hole and is supported and guided in the cable guide element.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a perspective view of a portable electric vehicle charging device according to an embodiment of the invention;

FIG. 2 is a top perspective view of a transport module of the portable electric vehicle charging device of FIG. 1;

FIG. 3 is a bottom view of the portable electric vehicle charging device of FIGS. 1 and 2;

FIG. 4 is a bottom perspective view of the transport module of the portable electric vehicle charging device of FIGS. 1-3.

### DETAILED DESCRIPTION

An embodiment of the invention is discussed in detail below. In describing an embodiment, specific terminology is employed for the sake of clarity. However, the invention is not intended to be limited to the specific terminology so selected. A person skilled in the relevant art will recognize that other equivalent components can be employed and other methods developed without departing from the broad concepts of the invention. All references cited herein are incorporated by reference as if each had been individually incorporated.

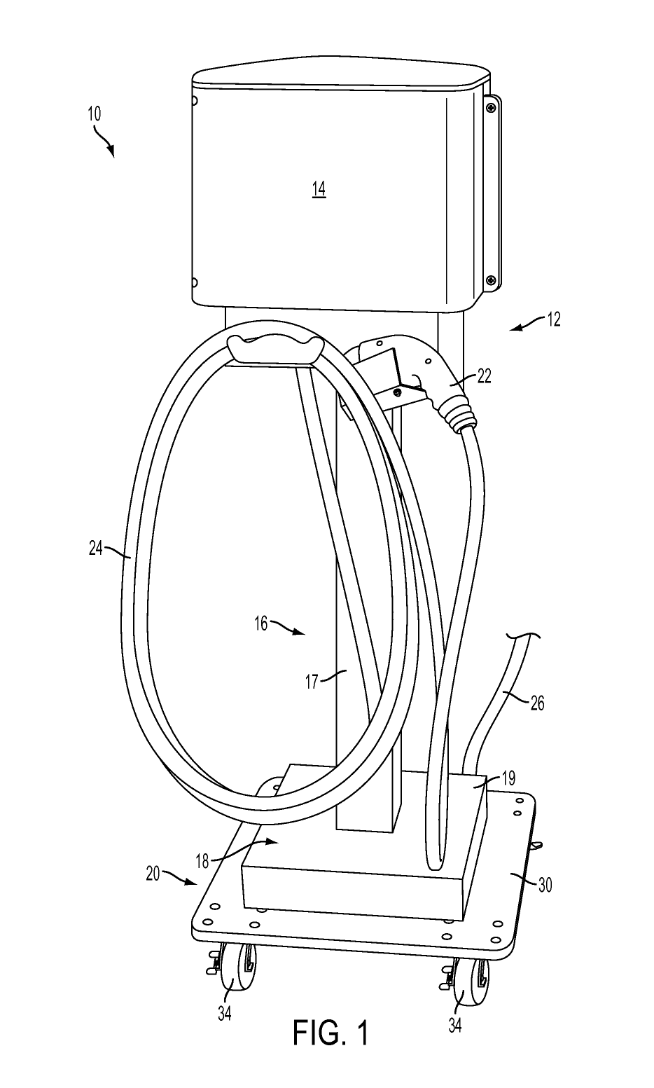

FIG. 1 is a perspective view of a portable electric vehicle charging device 10 according to an embodiment of the invention. As shown in FIG. 1, the portable electric vehicle charging device 10 includes electric vehicle supply equipment 12, a housing enclosure 14, a pedestal 16 having a base 18, and a transport module 20 coupled to the base 18. The electric vehicle supply equipment 12 can include an electric vehicle connector 22 having a cord 24 and being configured for connection to an electric vehicle inlet (not shown). The electric vehicle supply equipment 12 can include a service entrance cable 26 arranged to be connected to the premises wiring to deliver energy to the electric vehicle connector 22. The electric vehicle supply equipment 12 can also include any ungrounded, grounded, and equipment grounding conductors, attachment plugs, and other fittings, devices, power outlets, or apparatuses necessary to deliver energy from the premises wiring (not shown) to the electric vehicle (not shown), all or a portion of which may be enclosed within housing enclosure 14. The pedestal 16 is coupled to and supports the housing enclosure 14 and may include a hollow tubular portion 17 and a base 18. The base 18 may include a base cover 19 and a base plate (not shown) configured to engage and be supported on a top surface of the transport module 20. The subassembly, including the electric vehicle supply equipment 12 (including electric vehicle connector 22, cord 24, and service entrance cable 26), the housing enclosure 14, and the pedestal 16 (including hollow tubular portion 17 and base 18), may be a commercially available electric vehicle charge station such as, for example but not limited to, a CS Series Public EVSE provided by ClipperCreek, Inc. of Auburn, Calif.

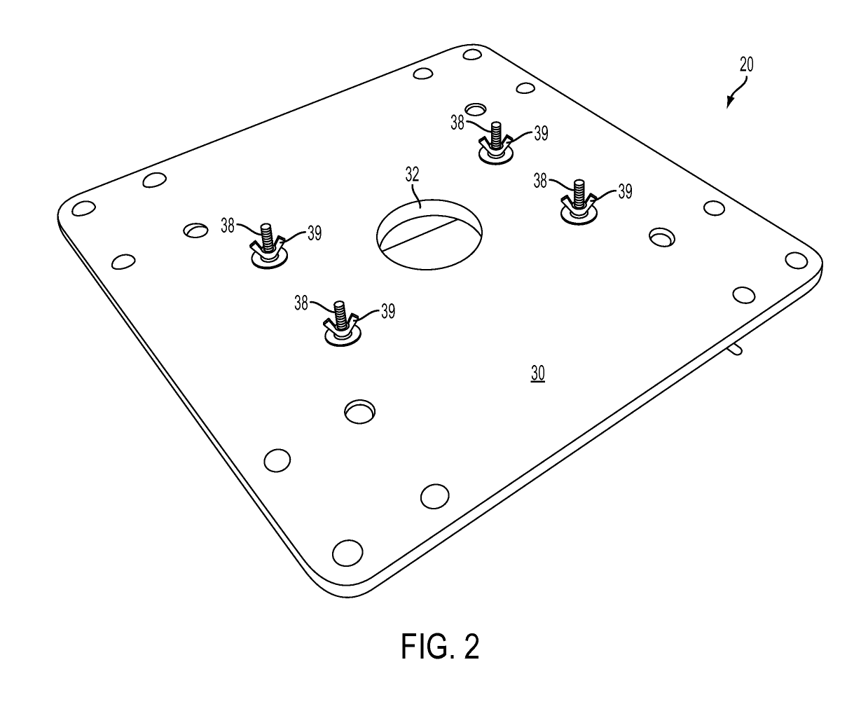

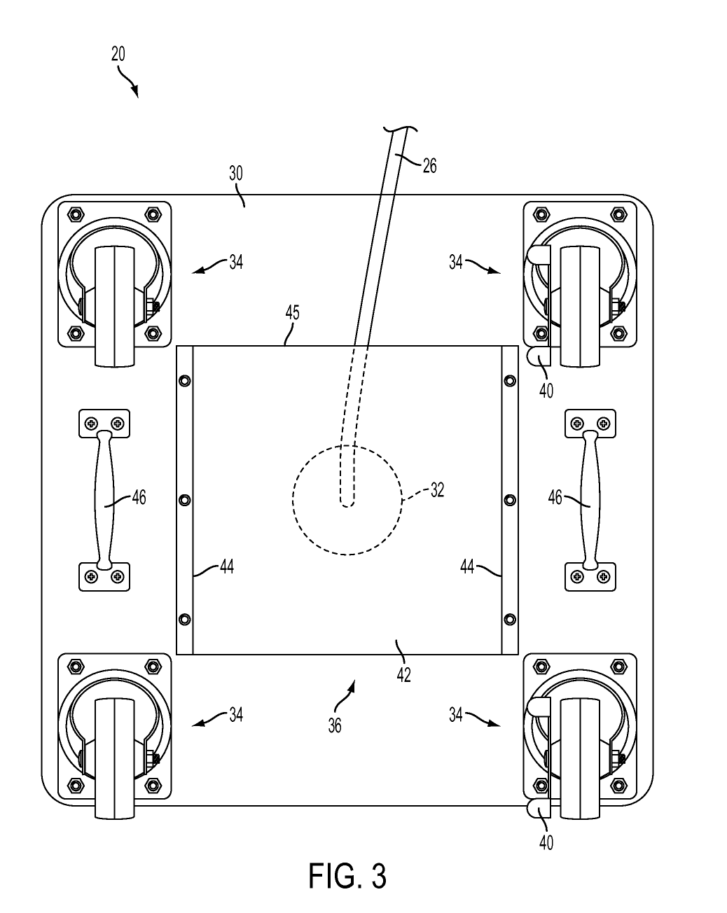

The transport module 20 may be coupled to the base 18 of the pedestal 16 and includes a plurality of wheels 34 to allow a user to easily move the electric vehicle charging device 10 over a horizontal surface such as the ground or the floor of a building when transporting the device. The transport module 20 includes a platform 30 having a through hole 32 (see FIGS. 2 and 3). The plurality of wheels 34 may be, for example, coupled to a bottom surface of the platform 30. The platform 30 may be formed of, for example but not limited to, a wood material, a metal material, a plastic material, a composite material, or a combination thereof so long as the material is sufficiently rigid and durable to statically and dynamically support the pedestal 16 and electric vehicle supply equipment 12.

In another embodiment, the transport module 20 may be coupled to the housing enclosure 14 without using the base 18 or the pedestal 16.

In another embodiment, the transport module 20 may be coupled to the base 18, which is not coupled to a pedestal 16, but is coupled to the housing enclosure 14.

FIG. 2 is a top perspective view of the transport module 20 of the portable electric vehicle charging device 10 of FIG. 1. As shown in FIG. 2, the platform 30 of the transport module 20 includes the through hole 32, which may be positioned in approximately the center of the platform 30, although other positions are possible to accommodate pedestals and electric vehicle supply equipment having configurations other than that depicted in the embodiment. The platform 30 may include a plurality of fasteners 38 for releaseably or removeably securing the base 18 of the pedestal 16 to the transport module 20. The fasteners 38 may include, for example but not limited to, a plurality of bolts and wing nuts 39 arranged to receive and fix the base plate (not shown) of the base 18 to the upper surface of the platform 30.

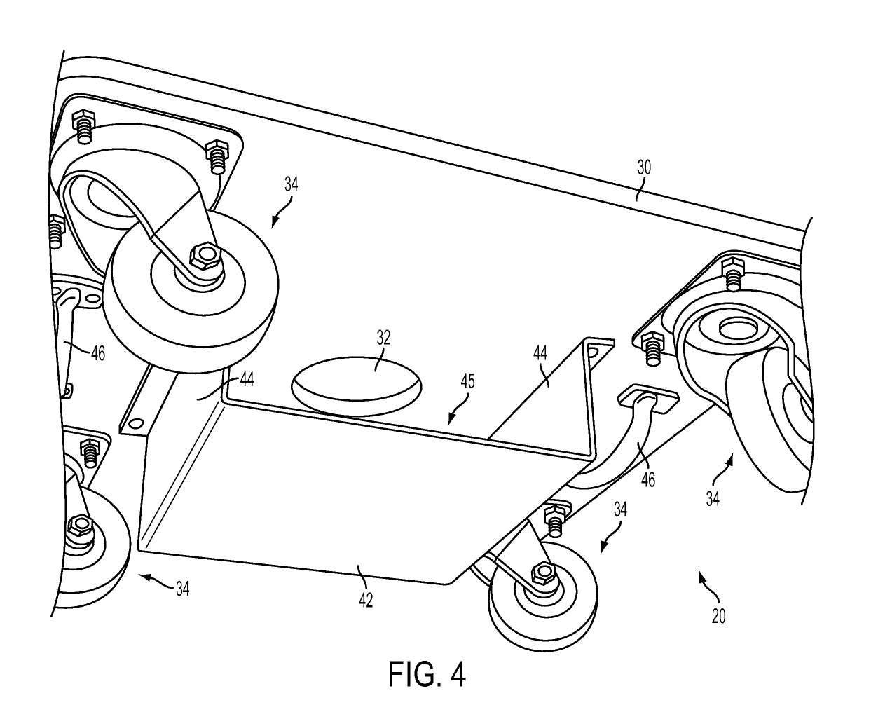

FIG. 3 is a bottom view of the portable electric vehicle charging device 10 of FIGS. 1 and 2. FIG. 4 is a bottom perspective view of the transport module 20 of the portable electric vehicle charging device 10 of FIGS. 1-3. As shown in FIGS. 3 and 4, the bottom surface of platform 30 includes the plurality of wheels 34, each of which may be, for example but not limited to, a multi-directional swivel caster. One or more of the wheels 34 may also include a braking mechanism 40 configured to lock the respective wheel 34 in place when activated and thereby prevent movement of the electric vehicle charging device 10 if desired. For example, braking mechanism 40 may include a manually operable friction brake configured to releaseably engage a portion of the wheel 34 and prevent rotation thereof.

A cable guide element 36 may be coupled to the bottom surface of the platform 30 beneath the though hole 32. The guide element 36 may be in the form of, for example but not limited to, a tray having a primary support surface 42 and one or more side walls 44 connected to the bottom surface of the platform 30 and defining an opening 45 on at least one other side. In the embodiment depicted in FIGS. 3-4, side walls 44 are spaced apart from one another by surface 42 to define a U-shaped tray having openings 45 on two other sides. In this way, the tray may define a partially enclosed region beneath the through hole 32. The service entrance cable 26 of the electric vehicle supply equipment 12 may extend from the housing enclosure 14, through the hollow tubular portion 17 of the pedestal 16, through the through hole 32 in the platform 30, and may be supported above the ground and guided by the primary support surface 42 through the opening 45 of the tray 36 for connection to the premises wiring.

The platform 30 may also include one or more handles 46 which may be, for example but not limited to, attached to or integrally formed on the bottom or top surface of the platform 30 to provide a user operating the electric vehicle charging device 10 with a gripping point, for example, when lifting the device 10 into or out of a vehicle. The handle 46 may also allow a user to easily carry the transport module 20 when detached from the base 18. The handle 46 may also be integrally formed in the platform 30 by providing an appropriately sized and shaped through hole adjacent to an outer periphery of the platform 30.

In another embodiment, the tray 36 may include other configurations and shapes than shown in FIGS. 3-4. For example, the tray 36 may occupy a portion of the bottom surface of the platform not occupied by wheels 34 and handles 46.

In another embodiment, the base 18 may be rotatably connected to the transport module 20 with, for example but not limited to, a ball bearing ring assembly (not shown). With this configuration, the subassembly of the electric vehicle supply equipment 12, the housing enclosure 14, and the pedestal 16 may swivel with respect to the transport module 20. As such, a face of the housing enclosure 14 having indicators to be viewed by a user may be rotated by the user without tangling the service entrance cable 26. A rotary locking mechanism (not shown) may also be included with the rotatable connection between the base 18 and the transport module 20, so as to lock a desired position between the base 18 and the transport module 20.

According to another embodiment, the base 18 may be fixedly connected to the transport module 20 and one of the housing enclosure 14 and the pedestal 16 may be configured to rotate relative to the other elements, including the base 18 and the transport module 20. As such, a face of the housing enclosure 14 having indicators to be viewed by a user may be rotated by the user without tangling the service entrance cable 26. A rotary locking mechanism (not shown) may also be included with the rotatable connection between the pedestal 16 and the base 18 or between the housing enclosure 14 and the pedestal 16, so as to lock the housing enclosure 14 in a desired position relative to the base 18 and transport module 20.

While embodiments of the invention have been described herein, it should be understood that it has been presented by way of example only, and not limitation. Thus, the breadth and scope of the invention should not be limited by any of the described embodiments, but should instead be defined only in accordance with the following claims and their equivalents.

What is claimed is:

1. A portable electric vehicle charging device, comprising:
electric vehicle supply equipment including a service entrance cable and an electric vehicle connector configured for connection to an electric vehicle inlet, at least a portion of the electric vehicle supply equipment disposed in a housing enclosure;
a pedestal coupled to and supporting the housing enclosure and including a base;
a transport module coupled to the base of the pedestal and comprising:
a platform having a through hole;
a plurality of wheels coupled to a bottom surface of the platform;
a cable guide element coupled to the bottom surface of the platform beneath the though hole, wherein the service entrance cable extends from the housing enclosure through the through hole and is supported and guided in the cable guide element.

2. The portable electric vehicle charging device according to claim 1, wherein the pedestal is hollow and the service entrance cable extends from the housing enclosure through the pedestal to the through hole.

3. The portable electric vehicle charging device according to claim 1, wherein the through hole is disposed substantially in a center of the platform.

4. The portable electric vehicle charging device according to claim 1, wherein the cable guide element comprises a tray coupled to the bottom surface of the platform and defining a partially enclosed region beneath the through hole.

5. The portable electric vehicle charging device according to claim 4, wherein the tray includes a bottom surface and at least one side wall.

6. The portable electric vehicle charging device according to claim 1, wherein the transport module is removably coupled to the base.

7. The portable electric vehicle charging device according to claim 6, wherein a plurality of fasteners fasten the base to the platform.

8. The portable electric vehicle charging device according to claim 1, wherein the transport module further comprises a handle.

9. The portable electric vehicle charging device according to claim 8, wherein the handle is coupled to the platform.

10. The portable electric vehicle charging device according to claim 9, wherein the handle is coupled to the bottom surface of the platform.

11. The portable electric vehicle charging device according to claim 1, wherein the plurality of wheels comprise multi-directional swivel casters.

12. The portable electric vehicle charging device according to claim 11, wherein at least one of the multi-directional swivel casters includes a brake.

13. The portable electric vehicle charging device according to claim 1, wherein the platform comprises a wood material, a metal material, a plastic material, a composite material, or a combination thereof.

14. The portable electric vehicle charging device according to claim 1, wherein the housing enclosure is rotatable relative to the transport module.

15. A transport module for an electric vehicle charging device, comprising:
a platform having a through hole;
a plurality of wheels coupled to a bottom surface of the platform; and
a cable guide element coupled to the bottom surface of the platform beneath the though hole, wherein when the transport module is coupled to the electric vehicle charging device, a service entrance cable extends from electric vehicle supply equipment of the electric vehicle charging device through the through hole and is supported and guided in the cable guide element.

16. The transport module according to claim 15, wherein the through hole is disposed substantially in a center of the platform.

17. The transport module according to claim 15, wherein the cable guide element comprises a tray coupled to the bottom surface of the platform and defining a partially enclosed region beneath the through hole.

18. The transport module according to claim 17, wherein the tray includes a bottom surface and at least one side wall.

19. The transport module according to claim 15, further comprising a handle coupled to the platform.

20. The transport module according to claim 15, wherein the platform comprises a wood material, a metal material, a plastic material, a composite material, or a combination thereof.
